(19) United States
(12) Patent Application Publication
(10) Pub. No.: US 2010/0235464 A1
(43) Pub. Date: Sep. 16, 2010

(54) HANDOFF AND OPTIMIZATION OF A NETWORK PROTOCOL STACK

(76) Inventors: Mahadaven Iyer, Gyconggi-do (KR); Albert Lee, Aliso Viejo, CA (US)

Correspondence Address: PROCOPIO, CORY, HARGREAVES & SAVITCH LLP, 525 B STREET, SUITE 2200, SAN DIEGO, CA, 92101, US

(21) Appl. No.: 12/442,232

(22) PCT Filed: Sep. 20, 2006
(86) PCT No.: PCT/US06/36590

§ 371 Date: Apr. 20, 2010

(51) Int. Cl. G06F 15/16

(52) U.S. Cl. 709/217; 709/227

(57) ABSTRACT

There is provided a module for implementing handoff and/or quality optimization of a network protocol stack (308). The module is transparent to the network protocol stack (308) and an application (306) using the network protocol stack (308). The module includes session detector (402) and an auxiliary manager (410). The module may further include a request interceptor (404), a request analyzer (406) and controller (408). The session detector (402) detects an original session from a host to a remote host. The auxiliary session manager (410) opens and manages a plurality of auxiliary sessions to support the original session. The request interceptor (404) detects an original request issued by the application, wherein the original request is for retrieving certain content. The request analyzer (406) analyzes the intercepted original request. The controller (408) uses the original session and auxiliary sessions to retrieve the content based on the result of the analysis.

### FIELD OF THE INVENTION

The present invention generally relates to a method and module for optimizing a network protocol stack, and more particularly to a transparent and one-sided method and module for implementing handoff and/or quality optimization of a network protocol stack.

### BACKGROUND OF THE INVENTION

Most network protocol suites are structured as a series of layers, which are sometimes collectively referred to as a protocol stack. In this regard, Open Systems Interconnect (OSI) reference model describes network activities as having a structure of seven layers, each of which has one or more protocols associated therewith. As shown in FIG. 1, the protocol layers of the OSI reference model are traditionally listed from the top (layer 7) to the bottom (layer 1).

The operations defined by the OSI reference model are purely conceptual and are not unique to any particular network protocol suite. For example, the OSI network protocol suite implements all seven layers of the OSI reference model. On the contrary, TCP/IP, which is one of the most commonly used network protocol suites in the Internet environment, does not directly correspond to the OSI reference model, as it combines several OSI layers into a single layer. FIG. 2 describes the layers of a TCP/IP implementation from the uppermost layer (application) to the lowest layer (physical network). FIG. 2 shows the layers of the TCP/IP stack, their OSI model equivalents and the examples of protocols available at each level of the stack.

Among the layers of the TCP/IP stack, the physical network layer specifies the characteristics of the hardware to be used for the network. For example, it specifies the physical characteristics of the communications media. The data-link layer identifies the network protocol type of the packet. It also provides error control and “framing.” The internet layer, which is also known as the network layer, accepts and delivers the packets for the network. Further, the transport layer protocols, including Transmission Control Protocol (TCP), ensure that the packets arrive in sequence and without error by swapping acknowledgments of data reception and retransmitting lost packets. TCP enables applications to communicate with each other as though connected by a physical circuit.

The application layer defines the standard Internet services and network applications. These services work with the transport layer in order to send and receive data. Some examples of the application layer protocols include HyperText Transfer Protocol (HTTP), File Transfer Protocol (FTP), telnet and Network File System (NFS). Most of the application layer protocols manage sessions to remote hosts. Commands and data are transferred through the sessions. For example, when a host issues an HTTP request to retrieve certain content from a remote host, the HTTP request is sent from the application layer of the host to the application layer of the remote host through a session established therebetween. Moreover, in response to the HTTP request, the remote host transfers the requested content as an HTTP response back to the host through the same session.

Each layer in the conventional network protocol suites is designed so that a specific layer of one machine sends or receives exactly the same object sent or received by its corresponding layer of another machine (i.e., one-to-one correspondence). However, this one-to-one correspondence hinders the full usage of network bandwidth and the processing resources of the remote host.

The TCP/IP protocol suite is becoming more and more popular in wireless network environments. Since a host can move from one network to another network in the wireless network environment, there is a strong need for seamless and cost-effective handoff so as to provide a high quality of service. However, since the conventional network protocol suites employ one-to-one correspondence sessions as described above, it is extremely difficult to provide such seamless and cost-effective handoff.

Further, conventional client applications and server programs are based on the conventional TCP/IP protocol suites. Therefore, in order to continue the use of conventional client applications and server programs, the solution to the above drawbacks should be transparent and one-sided. Herein, the term “transparent” means that there is no need for any modification to the existing applications, network protocol stack and socket implementations at the communicating hosts used in the session nor any new servers or other infrastructure. Further, the term “one-sided” means that the solution only needs to be implemented at one of the communicating hosts used in the session.

### SUMMARY OF THE INVENTION

It is, therefore, an object of the present invention to provide a transparent and one-sided method to achieve quality of service (QoS) improvement and inter-network handoff for sessions. It is another object of the present invention to provide a module to achieve QoS improvement and inter-network handoff for sessions in a transparent and one-sided manner.

According to one aspect of the present invention, there is provided a module for implementing handoff and/or quality optimization of a network protocol stack. The module is transparent to the network protocol stack and the application using the network protocol stack. The module includes a session detector and an auxiliary session manager. The session detector detects an original session from a host to a remote host, whereas the auxiliary session manager opens and manages a plurality of auxiliary sessions to support the original session. Also, the module may further include a request interceptor, a request analyzer and a request controller. The request interceptor detects an original request issued by the application, wherein the original request is for retrieving certain content. The request analyzer analyzes the intercepted original request. The request controller uses the original session and the auxiliary sessions to retrieve the content based on the result of the analysis.

According to another aspect of the present invention, there is provided a method for implementing quality optimization of a network protocol stack. The method includes detecting an original session and opening a plurality of auxiliary sessions to support the original session. The original session and the auxiliary sessions are used to perform an original request issued by an application using the network protocol stack. Herein, the method is transparent to the application and the network protocol stack. Further, the original request may be for retrieving certain content. In this case, the use of the original session and the auxiliary sessions may include: intercepting the original request; determining one or more portions of the content that collectively cover the content; retrieving the portions of the content through the original session and the auxiliary sessions; merging the portions to construct the content; and providing the content to the application.

According to yet another aspect of the present invention, there is provided a method for implementing handoff on a network protocol stack. The method includes: detecting an original session established over a first network by an application using the network protocol stack; and opening an auxiliary session over a second network to support the original session. The method further includes inducing teardown of the original session. The method is transparent to the application and the network protocol stack. Herein, the auxiliary session may be opened in response to entrance into the second network. Also, the method may further include detecting an original request to retrieve certain content. In this case, the method includes starting retrieval of the content through the original session and further performing a continual retrieval of the content through the auxiliary session.

The following terms are defined in this specification as below:

“Adport” or “endpoint” means a pair of IP address and port number, which identify an endpoint of an Internet session;

“Transfer-complete state” means a state where the packets of a session delivered to the TCP/IP stack have covered the entire content requested through the session;

“End-of-transfer packet” means a packet involved in the teardown of a TCP/IP session (e.g., TCP FIN or RST packet); and

“Cumulative ack number of a packet” means the number b such that the sender of the packet is guaranteed to have received all the bytes of the content preceding the number b during the TCP/IP session to which the packet belongs.

### BRIEF DESCRIPTION OF THE DRAWINGS

The above and other objects and features in accordance with the present invention will become apparent from the following descriptions of preferred embodiments given in conjunction with the accompanying drawings, in which:

FIG. 1 shows the protocol layers of an OSI reference model from the top (layer 7) to the bottom (layer 1);

FIG. 2 shows the layers of TCP/IP stack, their OSI model equivalents and the examples of protocols available at each level of the stack;

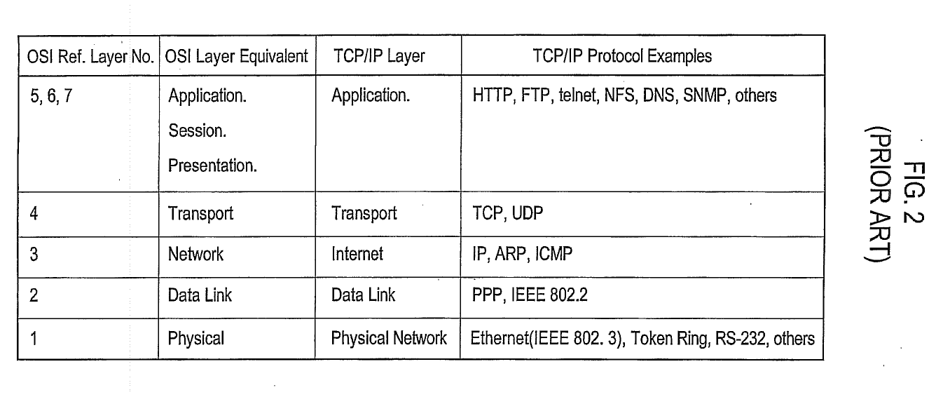

FIG. 3 schematically illustrates an exemplary environment wherein a module constructed in accordance with a first preferred embodiment of the present invention is employed;

FIG. 4 shows an exemplary structure of the module constructed in accordance with the first preferred embodiment;

FIG. 5 schematically illustrates an exemplary environment wherein a module constructed in accordance with a second preferred embodiment of the present invention is employed;

FIG. 6 shows an exemplary structure of the module constructed in accordance with the second preferred embodiment;

FIG. 7 is a flowchart of a method in accordance with a third preferred embodiment of the present invention; and

FIG. 8 is a flowchart of a method in accordance with a fourth preferred embodiment of the present invention.

### DETAILED DESCRIPTION OF THE PRESENT INVENTION

In the following description, numerous specific details are set forth in order to provide a thorough understanding of the present invention. It will be apparent, however, to one stilled in the art, that the present invention may be practiced without some or all of these specific details. In other instances, well known process steps have not been described in detail so as not to unnecessarily obscure the present invention.

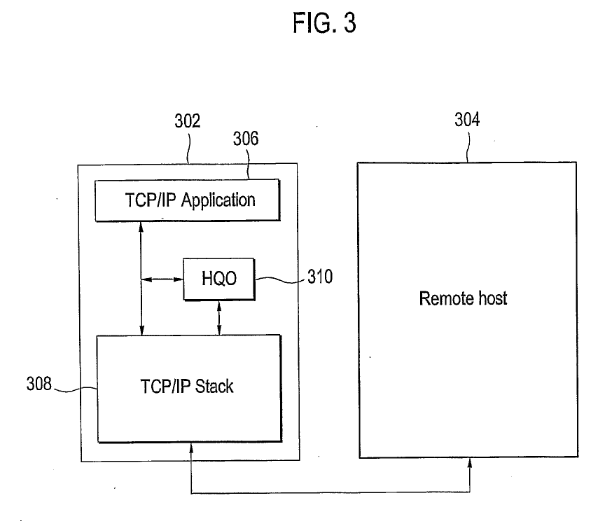

FIG. 3 schematically illustrates an exemplary environment wherein a module, which is constructed in accordance with a first preferred embodiment of the present invention, is employed. Referring now to FIG. 3, a host 302 includes a TCP/IP application 306 that communicates through a TCP/IP stack 308 to a remote host 304. The TCP/IP application 306 may be, for example, a web browser. The host 302 opens an HTTP session S to download a web page W of size P from a remote host 304. The web page W may represent the entire content of a web page, including HTML documents, embedded data, images and the like. Although this embodiment is described using TCP/IP and HTTP for simplicity, it should be noted that the present invention is not limited thereto. On the contrary, the present invention can be applied in a similar manner to other network protocols as well as other application protocols including FTP and the like.

The host 302 may include the module 310, namely HQO (Handoff/QoS Optimizer), which is in accordance with the first preferred embodiment. The HQO module 310 may reside between the TCP/IP application 306 (or an application layer) and the TCP/IP stack 308 (or a transport layer), and interact with them.

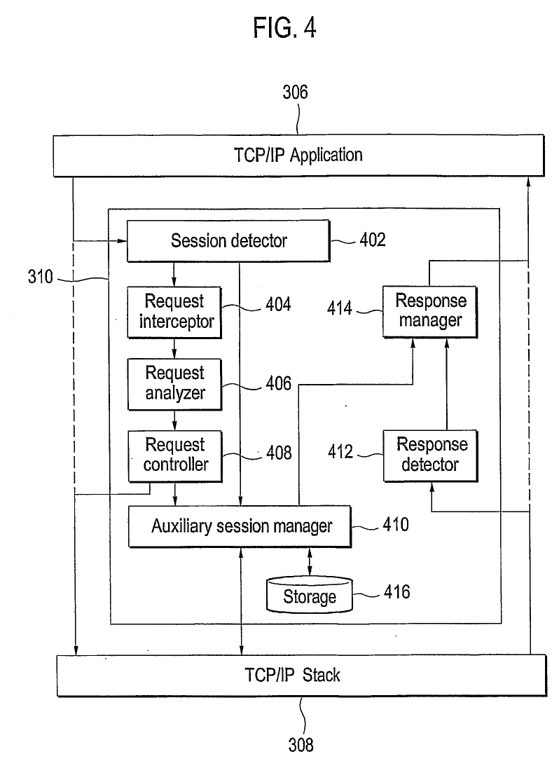

FIG. 4 shows an exemplary structure of the HQO module 310, which is constructed in accordance with the first preferred embodiment. As shown in FIG. 4, the HQO module 310 generally includes a session detector 402, a request interceptor 404, a request analyzer 406, a request controller 408, an auxiliary session manager 410, a response detector 412, a response manager 414 and a storage 416.

The session detector 402 detects the opening of the original session S from the host 302 to the remote host 304, and intercepts the original session S. Upon detection, the auxiliary session manager 410 opens and manages one or more auxiliary sessions to support the original session S. Herein, the auxiliary sessions do not need to be directed to the same remote host, but can be established to the respective remote hosts in which each can be potentially different from the remote host 304.

The request interceptor 404 detects HTTP requests, which are transferred through the original session S. The detected HTTP requests are provided to the request analyzer 406, wherein the HTTP requests are parsed and analyzed. The request controller 408 receives the analysis result and determines the suitable number of portions of the web page W, wherein the portions collectively cover the entire web page W. The portions may or may not overlap with each other and need not have the same size. In determining the portions, the request controller 408 may refer to the information regarding the auxiliary sessions. For example, the request controller 408 may refer to the number of currently established auxiliary sessions to determine the suitable number. For example, when three auxiliary sessions are established to support the original session S, the request controller 408 may determine the number of portions to be four. Upon such determination, the request controller 408 requests each of the determined portions through the original session S or one of the auxiliary sessions. The request controller 408 may also determine the number of portions to be one, which results in downloading the entire web page W through the original session S.

In response to the requests from the request controller 408, the remote host 304 transfers the requested portions of the web page W through the original session S and the auxiliary sessions. The portions transferred through the auxiliary sessions are provided by the auxiliary session manager 410 to the response manager 414. Further, the response detector 412 intercepts the portion transferred through the original session S and provides such portion to the response manager 414. The response manager 414 constructs the entire web page W based on the received portions and provides the constructed web page W to the TCP/IP application as HTTP responses.

The operations of the request controller 408 will be described below in more detail with illustrative examples.

In one example, when the number of portions is determined to be four, the request controller 408 may force the original session S and the auxiliary sessions to download a quarter of the web page W each. In other words, considering that the web page W has the size P, the request controller 408 may download the byte range of: 1 to P/4 through the original session S; P/4+1 to P/2 through a first auxiliary session; P/2+1 to 3P/4 through a second auxiliary session; and 3P/4+1 to P through a third auxiliary session. The support for requesting only a portion of the web page W is provided in most web servers today by using the “Range” header in the request header fields. The “Range” header is specified in Sections 5.3 and 14.35 of HTTP/1.1 (RFC 2616).

More specifically, the request controller 408 may modify the original HTTP requests so that the modified HTTP requests request only a portion of the web page W instead of the entire web page W. This modification is referred to as truncation of the original session S. For example, the request controller 408 may introduce the “Range” field to the existing HTTP headers of the HTTP requests. The request controller 408 then sends the modified HTTP requests through the original session S. In addition, the request controller 408 may construct auxiliary HTTP requests that request the other portions of the web page W, which are sent through the auxiliary sessions. While sending the auxiliary HTTP requests, the request controller 408 may provide the auxiliary session manager 410 with information regarding the locations of where the respective portions occupy in the entire web page W. The auxiliary session manager 410 may store the provided information regarding the locations in the storage 416. When the respective portions of the web page W are received through the auxiliary sessions, the auxiliary session manager 410 retrieves the information regarding the locations from the storage 416 and provides the same to the response manager 414 so as to assist the response manager 414 to construct the entire web page W. For example, the response manager 414 may parse HTTP responses to extract the portions of the web page W from their bodies and then assemble the portions based on the information of locations to construct the entire web page W.

In another example, the web page W may represent the entire content of a web page, including HTML documents, embedded data, images and the like. Such various parts of the web page W can be indicated by a plurality of URIs (universal resource identifiers). In this case, the request controller 408 may determine the portions of the web page W to be the parts indicated by the respective URIs. For example, the web page W may include a base HTML document and two embedded images A and B, wherein the URIs of the images are contained in the base HTML document. In this case, the request controller 408 may determine the base HTML document, image A and image B, respectively, as individual portions of the web page W. Accordingly, the base HTML document, image A and image B can be downloaded in parallel through the original session S and the auxiliary sessions along the respective URIs. The modification of the HTTP headers may not be mandatory.

Moreover, the original session S and the auxiliary sessions can have different paths to the remote host 304. For example, some of the sessions may be connected to the remote host 304 over a relatively slow network (e.g., CDMA), while others are established over a relatively fast network (e.g., WiFi access). In this case, the request controller 408 may download larger portions via the faster route and smaller portions via the slower route so that the portions are downloaded as closely as possible to each other. For example, if the image A has a large size and the image B has a small size, then the request controller 408 may provide a control to download the image A through a session established over the fast WiFi access and the image B through a session established over the slow CDMA link.

According to the above embodiment, the download speed can be remarkably accelerated without modifying the application and the remote hosts. Specifically, the portions of the content can be downloaded in parallel. Thus, the actual download can be dramatically accelerated without any modification to the existing programs. For example, in the above case where the truncated original session and three auxiliary sessions download quarters of the web page W in parallel, the download of the web page W can become approximately four times faster, assuming that a sufficiently bottlenecked web server or network route is used. More specifically, if the number of auxiliary sessions is set to be high enough, then the download can be accelerated to efficiently fill up the bottleneck bandwidth available in the network path between the host and the remote host. Meanwhile, the original and auxiliary sessions jointly form a virtual fast TCP connection, which prevents the useless slow start behavior.

Further, since the response manager 414 provides the entire content as a normal HTTP response, the TCP/IP application does not need to know about the existence of the HQO module 310. That is, the TCP/IP application can send the same HTTP requests as it would send when the HQO module 310 is not present and receive the identical HTTP responses as it would receive when the HQO module 310 is not present. Consequently, the HQO module 310 is transparent to the TCP/IP application and any existing applications can be used as they are. Moreover, the HQO module 310 and the auxiliary sessions are totally transparent to the conventional TCP/IP stack and the remote host. Since the HTTP requests from the request controller 408 are normal HTTP requests satisfying HTTP standards, the remote host 304 can be a typical web server. Thus, no modification is needed for the remote host 304. In other words, the remote host 304 does not need an additional peer module or peer layer that corresponds to the HQO module 310. Accordingly, the present embodiment provides a completely transparent and one-sided solution.

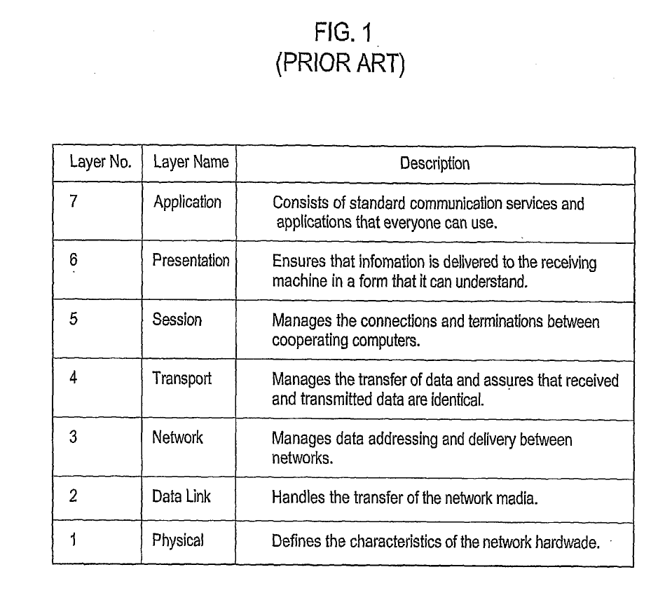

Further, although not shown in FIG. 1, the request controller 408 may send requests to the remote host 304 to find out the size P of the web page W before determining the portions. For example, the request controller 408 may obtain information on the size P from HTTP headers of an HTTP response received from the remote host 304.

In the above embodiment, the HQO module 310 resides between the TCP/IP application (or the application layer) and the TCP/IP stack (or the transport layer). However, it should be noted that the present invention is certainly not limited thereto. The HQO module 310 may reside below the transport layer.

In this case, the request controller 408 may serve to modify the payload in appropriate packets of the request. For example, the request controller 408 may modify application-layer headers in the payload of the packets so as to force the remote host 304 to send only a portion instead of the entire content (truncation of the original session). Also, along with the truncation of the original session, the request controller 408 may construct packets that include auxiliary requests for the other portions of the content. The constructed packets are sent through the auxiliary session manager 410.

The response manager 414 receives the portions of the content from the remote host 304 through the auxiliary session manager 410 and the response detector 412. As the portions collectively cover the entire content, the response manager 414 can use the received portions to construct the entire content (merging of the portions), which in turn is provided to the upper layer. In one example of the merging, the response manager 414 buffers IP packets received from each of the original session and the auxiliary sessions. It then releases the buffered IP packets to the upper layer in the exact original sequence and form that they would have been received if the entire content was requested through the original session. For this purpose, the response manager 414 may make the appropriate changes to the adport values in each of such packets to make it appear as though the packet comes from the original session. Further, the response manager 414 may shift the TCP sequence number and acknowledgement fields in each of such packets to reflect its correct position in the sequence of packets that would have resulted from the original session. This example will be described below in more detail.

For each incoming packet p from the auxiliary session manager 410, the response manager 414 determines if the packet p carries a portion of the web page W that has not already been delivered from the response manager 414 to the upper layer.

If so, the response manager 414 replaces the values of the source and destination adport fields in the packet p with the source and destination adport values of the original session; replaces the value in the sequence number field of the packet p (if such a field is present) with the original position of the first payload byte of the packet p in the web page W; and replaces the value in the acknowledgement number field of the packet p (if such a field is present) with the sum of a local variable “latest_seen_ack_number” and the length of the layer-4 payload of the packet p.

The response manager 414 also determines if the packet p is an end-of-transfer packet. If so, the response manager 414 does not send it immediately to the upper layer. Instead of immediately forwarding the end-of-transfer packet p, the response manager 414 checks if the packet p marks the reception of the end of the web page W. If so, the end-of-transfer packet p is saved in a buffer. When the transfer-complete state has been achieved for the original session S, the end-of-transfer packet p is retrieved from the buffer and delivered to the upper layer. The merging operation may further include the following actions which may occur in the request analyzer 406 and the request controller 408. Also, for each outgoing packet p of an auxiliary session received from the upper layer, the request analyzer 406 checks if the packet p is an acknowledgement packet of the layer-4 protocol (which is usually TCP). If so, the request controller 408 updates the local variable “latest_seen_ack_number” to the value of the sequence number field of the packet p. Further, the request analyzer 406 checks if the cumulative ack number of the packet p is larger than the last byte of the portion actually requested through the original session S. If so, the request controller 408 drops the packet p. Otherwise, it sends the packet p to the lower layer.

The auxiliary sessions do not need to have the same endpoints as the original session. Specifically, the remote endpoints of the auxiliary sessions can be different from the original endpoint in the remote host 304 of the original session. Similarly, the local endpoints in the host 302 of the auxiliary sessions can be different from the local endpoint in the host 302 of the original session. Accordingly, the portions can be downloaded in parallel from a plurality of different remote hosts. Such a generalized method brings a wide variety of QoS improvements and application handoffs without departing from the scope of the present invention.

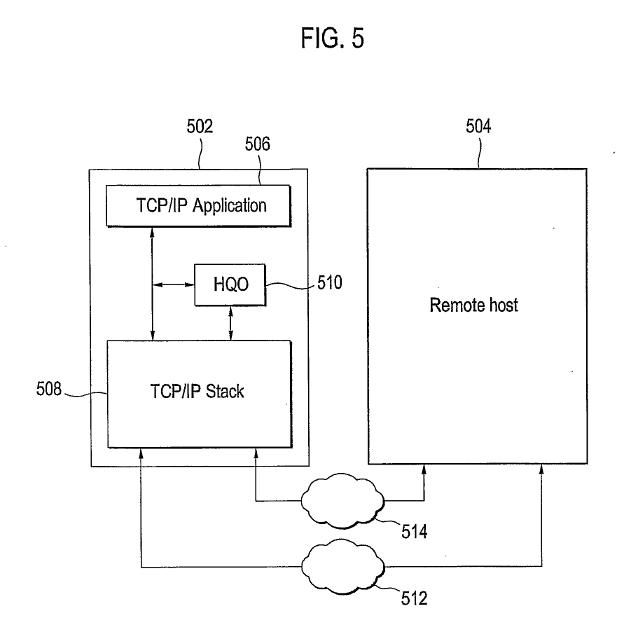

The second preferred embodiment of the present invention is described below. FIG. 5 schematically illustrates an exemplary environment wherein a module, which is constructed in accordance with the second preferred embodiment, is employed. As shown in FIG. 5, a host 502 includes a TCP/IP application 506 that communicates through a TCP/IP stack 508 to a remote host 504. The host 502 may further include the HQO module 510 constructed in accordance with this embodiment.

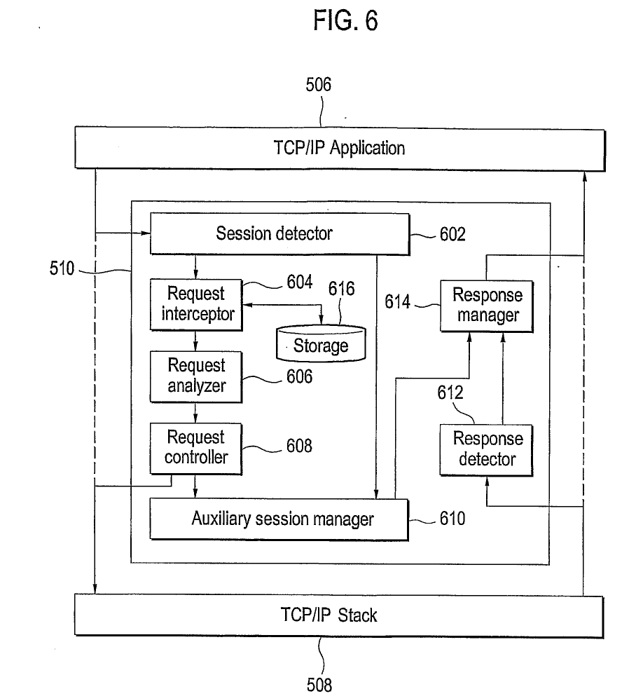

FIG. 6 shows an exemplary structure of the HQO module 510 constructed in accordance with the second preferred embodiment. As shown in FIG. 6, the HQO module 510 generally includes a session detector 602, a request interceptor 604, a request analyzer 606, a request controller 608, an auxiliary session manager 610, a response detector 612, a response manager 614 and a storage 616.

The following descriptions are provided with the assumption that the host 502 including the HQO module 510 moves from a first network 512 to a second network 514. For example, the host 502 may be a dual-mode CDMA-WiFi phone and the user moves from a CDMA cell into a WiFi hotspot. The first network 512 is CDMA and the second network 514 is the WiFi hotspot. However, this is just an illustration and should not limit the present invention in any way.

The TCP/IP application 506 may try to, for example, download a large file when the host 502 is within the first network 512. In this case, an original session S may be established over the first network 512 for the download and a request for the download is sent through the original session S. In response to such request, the remote host 504 starts to transfer the requested file through the original session S. Herein, the session detector 602 detects the original session S and the request interceptor 604 detects the request. The detected request may be kept in the storage 616 for future use. Later, when the host 502 enters the second network 514 while the requested file is still in transfer, the auxiliary session manager 610 opens and manages an auxiliary session over the second network 514. Preferably, the auxiliary session may be opened even before the original session S over the first network 512 gets broken. Meanwhile, the request stored in the storage 616 is provided to the request analyzer 606, which analyzes the request. Based on the analysis result, the request controller 608 constructs an auxiliary request to be sent through the auxiliary session managed by the auxiliary session manager 610.

In constructing the auxiliary request, the request controller 608 may refer to the amount of data that has already been received. For example, up to byte N of the file may have been received through the original session S at the start of the handoff. The response detector 612 may detect the number of received bytes N and inform the number N to the request controller 608, although not shown in FIG. 6. Then, the request controller 608 constructs the auxiliary request to request only the portion of the file from byte N+1 onwards. The request controller 608 sends the auxiliary request to the remote host 504 through the auxiliary session managed by the auxiliary session manager 610. In response to the auxiliary request, the remote host 504 starts to transfer the portion of the file from byte N+1 onwards through the auxiliary session, which is provided to the response manager 614. The original session S may stay opened during the handoff interval and the file download through the original session S may still be in progress. Therefore, some bytes from N+1 up to M may be doubly downloaded over the original session S and the auxiliary session. The response detector 612 intercepts the data downloaded through the original session S and provides it to the response manager 614. When the response manager 614 receives the doubly downloaded portion from the response detector 612 and the auxiliary session manager 610, the response manager 614 automatically discards any duplicate byte of the requested file received after the original byte has already been delivered to the TCP/IP application 506. In this way, the present embodiment can provide seamless and cost-effective application mobility.

Although this embodiment has been described with respect to a file download, it should be noted that the present invention is not limited thereto. On the contrary, the present invention can have many other applications.

For example, the HQO module 510 can be used for handoff of SIP sessions such as VoIP or SIP-IMS sessions with conference support provided in the SIP proxy servers. In this case, the original session S and the auxiliary session can be opened in conference mode. When the host 502 moves from one network into another network, the auxiliary session manager 610 establishes an auxiliary session to the remote host 504 by making another SIP call, which joins the existing conference via a session end-point different from the end-points used by the sessions currently in the conference. After establishing the auxiliary session, the request controller 608 induces the teardown of the original session S by exiting the conference and replaces the original session S with the auxiliary session. In this way, the auxiliary session takes over the original session S in a seamless manner.

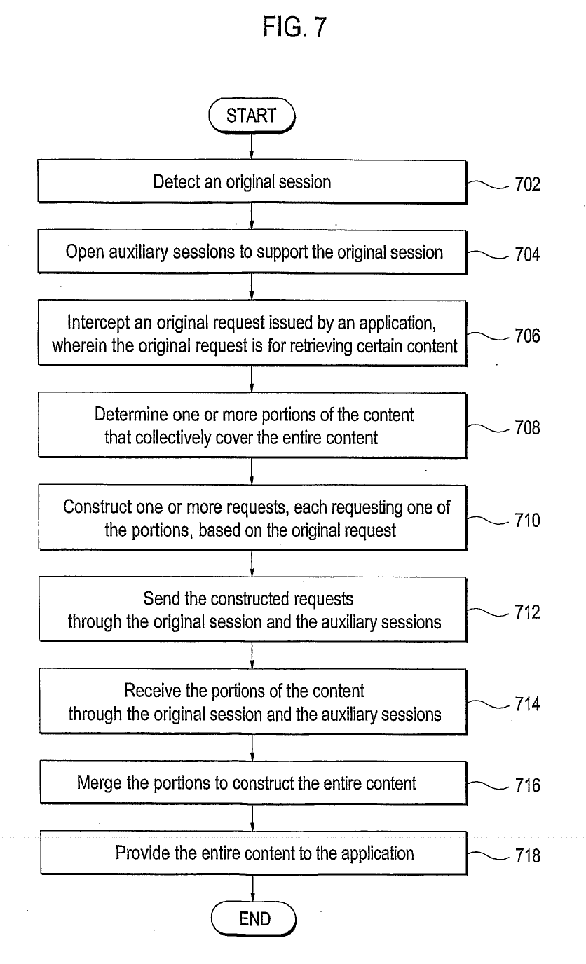

The third preferred embodiment of the present invention is described below. FIG. 7 is a flowchart illustrating a method, which is in accordance with the third preferred embodiment of the present invention. The method may be executed by, for example, the HQO module of the first preferred embodiment. The module detects an original session (702) and opens auxiliary sessions to support the original session (704). Herein, the auxiliary sessions may be opened in response to detecting the opening of the original session. Thereafter, the module uses the original session and the auxiliary sessions to perform an original request issued by an application layer, or a TCP/IP application. More specifically, the module intercepts the original request issued by the application layer (706), wherein the original request is for retrieving certain content. The module then determines one or more portions of the content that collectively cover the entire content (708). Then, the module retrieves the portions of the content through the original session and the auxiliary sessions. Specifically, the module constructs one or more requests (710), each of which requests one of the portions. In constructing the requests, the module may refer to the original request, and more particularly may modify the original request to construct the requests. The module sends the constructed requests through the original session and the auxiliary sessions (712). It then receives the portions of the content through the original session and the auxiliary sessions (714). The module merges the portions to construct the entire content (716). Finally, the module provides the constructed content to the application layer (718).

According to the present embodiment, the TCP/IP application, TCP/IP stack and the remote host do not require any modification. Further, the method may be executed only at one of the communicating hosts, and more particularly at the host issuing the original request. Therefore, the present embodiment provides a completely transparent and one-sided solution.

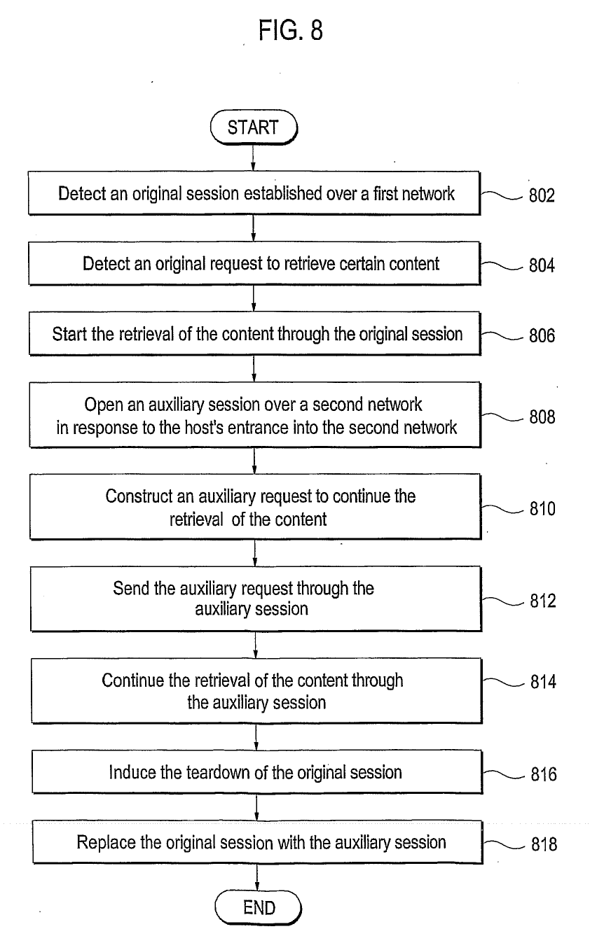

The fourth preferred embodiment of the present invention is described below. FIG. 8 is a flowchart illustrating a method, which is in accordance with the fourth preferred embodiment of the present invention. The method may be executed by, for example, the HQO module of the second preferred embodiment. The module detects an original session established over a first network (802). Then, the module detects an original request to retrieve certain content (804) and starts the retrieval of the content through the original session (806). If the host including the module enters a second network while the content is being retrieved, then the module opens an auxiliary session over the second network (808). Then, the module constructs an auxiliary request to continue the retrieval of the content (810) and sends the auxiliary request through the auxiliary session (812) to continue the retrieval of the content through the auxiliary session (814). The retrieval of the content through the auxiliary session may be partly duplicated with that through the original session. When a byte is received in duplicated through the original session and the auxiliary session, the module may discard the later received byte. Thereafter, the module induces the teardown of the original session (816) and replaces the original session with the auxiliary session (818). The present embodiment provides seamless and cost-effective application mobility

Although the above embodiments have been described with assuming the TCP/IP protocol suite, the present invention is not limited thereto. The present invention can be applied to other applicable protocol suites such as the OSI protocol suite.

The present invention provides a completely transparent and one-sided solution to achieve QoS improvement and inter-network handoff for TCP/IP sessions. Especially, for the user across different wireless networks, seamless and cost-effective application mobility can be provided. Also, for many typical dual-mode handset usage scenarios, zero handoff latency can be obtained with this invention. That is, no session pause, breaks or download degradation is perceived by the mobile user. Particular beneficial applications include VoIP (Voice over IP), mobile television, streaming or downloaded VOD (Video-On-Demand), popular P2P applications and most of other common user activities on the Internet. Moreover, the present invention provides a significant acceleration of web page downloads. For typical xDSL users, a dramatic acceleration of web page downloads in the range of 2-8 times the speeds that are possible today can be achieved. The internet service providers (ISPs) or content providers (CPs) do not need to install any new infrastructures for QoS improvement. The acceleration only requires the user downloads and installs the HQO module of the present invention on their computers or handsets. Once again, no mobility infrastructure is needed in the infrastructure network or on the content servers (transparency). The user only needs to apply the present invention on their computers or handsets (one-sidedness).

While the present invention has been shown and described with respect to preferred embodiments, those skilled in the art will recognize that various changes and modifications may be made without departing from the spirit and scope of the invention as defined in the appended claims.

1. A module for implementing handoff and quality optimization of a network protocol stack, comprising:
a session detector for detecting an original session from a host to a remote host; and
an auxiliary session manager configured to open and manage a plurality of auxiliary sessions to support the original session, wherein the module is transparent to the network protocol stack and an application using the network protocol stack.

2. The module of claim 1, wherein the auxiliary session manager opens the auxiliary sessions in response to detecting an opening of the original session.

3. The module of claim 1, wherein the module further comprises:
a request interceptor for detecting an original request issued by the application, wherein the original request is for retrieving a content;
a request analyzer coupled to analyze the intercepted original request; and
a request controller configured to use the original session and the auxiliary sessions to retrieve the content based on a result of the analysis.

4. The module of claim 3, wherein the request controller constructs at least one auxiliary request, wherein each of the auxiliary requests is for retrieving a portion of the content through one of the auxiliary sessions.

5. The module of claim 4, wherein the request controller modifies application-layer headers of the original request to request only a portion of the content through the original session.

6. The module of claim 5, wherein the module further comprises: a response manager for constructing the content based on the portions received in response to the modified original request and the auxiliary requests.

7. The module of claim 6, wherein the module further comprises: a storage for keeping information of locations where the respective portions occupy in the content, and wherein the response manager uses the information of the locations in constructing the content based on the portions.

8. The module of claim 1, wherein the network protocol stack is TCP/IP stack.

9. The module of claim 8, wherein the module resides between an application layer and a transport layer of the TCP/IP stack, and wherein the original and auxiliary sessions are TCP/IP sessions.

10. The module of claim 1, wherein the original session is established over a first network, and wherein the auxiliary session manager opens the auxiliary sessions in response to the host's entrance into a second network, and wherein the module further comprises:
a request interceptor for detecting an original request issued by the application, wherein the original request is for retrieving a content through the original session;
a request analyzer coupled to analyze the intercepted original request; and
a request controller configured to perform a continual retrieval of the content through the auxiliary sessions.

11. The module of claim 10, wherein the module further comprises: a response manager configured to discard a later received byte when a byte is received in duplicate through the original session and the auxiliary sessions.

12. A method for implementing quality optimization of a network protocol stack, comprising:
detecting an original session;
opening a plurality of auxiliary sessions to support the original session; and
using the original session and the auxiliary sessions to perform an original request issued by an application using the network protocol stack, wherein the method is transparent to the application and the network protocol stack.

13. The method of claim 12, wherein the auxiliary sessions are opened in response to detecting an opening of the original session.

14. The method of claim 12, wherein the original request is for retrieving a content, and wherein the operation of using includes:
intercepting the original request;
determining at least one portion of the content collectively covering the content; retrieving the portions of the content through the original session and the auxiliary sessions;
merging the portions to construct the content; and providing the content to the application.

15. The method of claim 14, wherein the operation of retrieving comprises:
constructing at least one request each requesting one of the portions based on the original request;
sending the constructed requests through the original session and the auxiliary sessions; and
receiving the portions of the content through the original session and the auxiliary sessions.

16. The method of claim 14, wherein the operation of determining comprises:
storing information of locations where the respective portions occupy in the content, and wherein the operation of merging includes:
retrieving the stored information of the locations; and
merging the portions based on the stored information of the locations.

17. The method of claim 15, wherein the operation of constructing comprises:
modifying payload in predetermined packets of the original request, and wherein the operation of merging comprises:
determining if a packet received through the auxiliary sessions carries a portion of the content that has not been delivered to the application;
if it is determined that the received packet carries a portion of the content that has not been delivered to the application, modifying values of source adport field, destination adport field, sequence number field and/or acknowledgement number field in the received packet;
determining if the received packet is an end-of-transfer packet; if it is determined that the received packet is an end-of-transfer packet, determining if the received packet marks reception of end of the content; and
if it is determined that the received packet marks reception of the end of the content, then deferring delivery of the received packet until a transfer-complete state is achieved for the original session.

18. The method of claim 12, wherein the network protocol stack is TCP/IP stack.

19. The method of claim 18, wherein the method is executed between an application layer and a transport layer of the TCP/IP stack, and wherein the original and auxiliary sessions are TCP/IP sessions.

20. A method for implementing handoff on a network protocol stack, comprising:
detecting an original session established over a first network by an application using the network protocol stack;
opening an auxiliary session over a second network to support the original session; and inducing a teardown of the original session, wherein the method is transparent to the application and the network protocol stack.

21. (canceled)

22. (canceled)
